(19) United States
(12) Patent Application Publication
(10) Pub. No.: US 2009/0070220 A1
(43) Pub. Date: Mar. 12, 2009

(54) METHOD FOR PROVIDING CONSUMER-DRIVEN WEB-BASED DIRECT MAIL ADVERTISING

(75) Inventor: Vincent Gross, Brick, NJ (US)

Correspondence Address: EDWARDS ANGELL PALMER & DODGE LLP, P.O. BOX 55874, BOSTON, MA, 02205, US

(73) Assignee: Home Improvement Shopper, LLC, Brick, NJ (US)

(21) Appl. No.: 12/205,507

(22) Filed: Sep. 5, 2008

Related U.S. Application Data
(60) Provisional application No. 60/970,423, filed on Sep. 6, 2007.

(51) Int. Cl. G06Q 30/00

(52) U.S. Cl. 705/14

(57) ABSTRACT

A method for web-based direct mail advertising that is consumer-driven and vendor-tracked is disclosed. A vendor is selected to participate in a web-based vendor tutorial and consumer-driven direct mail marketing service, while consumers are provided access to a web-based vendor promotions portal. Consumers receive information regarding access to the web-based promotions portal through a magnet postcard by mail, or alternatively, through radio, billboard or television advertisements. Once a consumer accesses the web-based vendor promotions portal, it can search for promotions of interest by selecting a geographic region and selecting a particular category of promotion. Based on the consumer search entries, vendor promotions of interest are retrieved and displayed to the consumer.

This application claims priority under 35 U.S.C. 119(e) to U.S. Provisional Application No. 60/970,423 filed Sep. 6, 2007, the entirety of which is hereby incorporated by reference.

### BACKGROUND OF THE INVENTION

The subject invention is directed to a method for providing web-based direct mail advertising, and more particularly, a method for consumer-driven and vendor-tracked advertising with exclusivity by industry category and geographic region and tracking the effect of such advertising.

Direct mail advertising has been in use for years. While useful as a marketing tool, direct mail advertising has some drawbacks. Typically, direct mail is comprised of bulk paper mailings, which are costly and consume environmental resources. Consumers are accustomed to receiving unsolicited paper mail advertising and often throw it away without viewing it. It does not get the attention of the desired audience. Other efforts to advertise through direct mail include mass email. Consumers are also accustomed to email advertising campaigns. These often fail due to the advent of personal email filters, where advertising emails are re-directed to a junk mail folder or deleted directly. The failures of direct mail advertising through paper mail and email are largely due to the fact that it is not driven by the consumer's interest.

Furthermore, direct mail advertising through both paper mail and email does not provide for efficient vendor tracking and does not facilitate consumer feedback to the vendor.

Accordingly, a methodology and system that overcome the shortcomings of the prior art are desired

### BRIEF SUMMARY OF THE INVENTION

In accordance with the invention, a method for web-based direct mail advertising that is consumer-driven and vendor-tracked is provided. According to one aspect of the invention, a vendor is selected to participate in a web-based vendor tutorial and consumer-driven direct mail marketing service. In another aspect of the invention, consumers are provided access to a web-based vendor promotions portal. Consumers receive information regarding access to the web-based promotions portal through a magnet postcard by mail, or alternatively, through radio, billboard or television advertisements. Once a consumer accesses the web-based vendor promotions portal, they can search for promotions of interest by selecting a geographic region and selecting a particular category of promotion. Consumers can implement the geographic search by entering a zip code corresponding to delivery location of the products and services. The category search can be implemented by selecting options from a pull-down menu at the portal. Based on the consumer search entries, the vendor promotions of interest are retrieved and displayed to the consumer.

In one feature of the invention, a consumer is provided a consumer feedback menu for submitting feedback to vendors. In another feature of the invention, a consumer can view a map to a vendor's place of business; agree to the terms of use of a vendor's promotion; print a vendor's promotion; enter an email address for receipt of future promotions; and connect to a vendor's website.

In yet another aspect of the invention, a vendor can track online consumer viewing and selection of its promotions. In addition, a vendor can make online changes to its promotions or account.

### BRIEF DESCRIPTION OF THE DRAWINGS

So that those skilled in the art will readily understand how to make and use the subject invention without undue experimentation, preferred embodiments thereof will be described in detail hereinbelow with reference to certain figures, wherein:

FIG. 1 is a schematic representation of the vendor activation mode of the method of the subject invention;

FIG. 2 is a schematic representation of the consumer activation mode of the method of the subject invention;

FIG. 3 is an exemplary screen shot illustrating the consumer interface of the subject invention, which includes menus for retrieving vendor promotions by geographic region and category in accordance with the method of the subject invention;

FIG. 4 is an exemplary screen shot illustrating the consumer interface of the subject invention, which includes a searching screen with a zip code entry box for selecting geographic regions of vendors, and a pull-down menu for selecting categories for vendor promotions in accordance with the method of the subject invention;

FIG. 5 is an exemplary screen shot illustrating a page populated with a vendor promotion display based on the selected geographic region and category in accordance with the method of the subject invention;

FIG. 6 is a screen shot showing an expanded vendor promotion display shown in FIG. 5; and

FIG. 7 is a detailed schematic representation of the use by vendors and consumers of the portal of the subject invention.

### DETAILED DESCRIPTION OF THE INVENTION

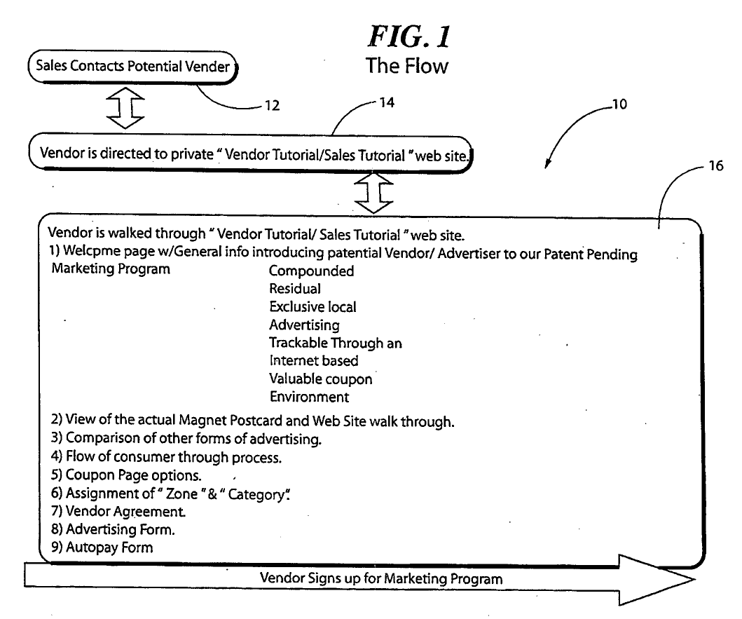

Referring now to the drawings wherein like reference numeral identify similar aspects or characteristics of the method the subject invention, there is illustrated in FIG. 1 a schematic representation of a vendor activation method in accordance with the subject invention, which is designated generally by reference numeral 10. In general, the method is directed to obtaining vendors to advertise across the worldwide web from a specific website portal and driving potential customers to the site.

In brief at step 12, sales persons contact potential vendors, at step 14, a vendor is directed to a web-based vendor tutorial, at step 16, a vendor is introduced to a web-based consumer-driven direct mail marketing service, and at step 18 a vendor signs-up for the web-based consumer-driven direct mail marketing service.

The tutorial itself provides to the vendor aspects of the novel marketing methodology. Because the tutorial is web-based, there is a first welcome page with general information introducing a potential vendor to the marketing program. The marketing program, as demonstrated below, provides exclusivity for advertising of services within a geographical area across the Internet. Internet generated coupons are utilized as part of the advertising methodology and may be tracked by assigning an ID number or such other identification to each coupon. Another aspect of the invention utilizes magnetic postcards to gain the initial attention of the consumer and drive potential customers to the website. The magnetic postcard is explained in the tutorial. The overall method is compared to other forms of advertising. How the consumer interacts with the website of this methodology is described along with types of coupons, how local geographic areas are assigned by category. A vendor agreement is utilized, an advertising form is utilized and payment procedures for the vendor are explained.

In the vendor activation mode, as vendors join, they are assigned to a category and a zip code in which they will provide services. Zip codes are assigned corresponding to a preferred but not limiting embodiment to a geographic region corresponding to the physical presence of the vendor, or where the vendor is capable of timely providing the goods or services. As is well understood, some chain vendors may have more than one physical presence. However, exclusivity is assigned to a vendor based upon category and geographical location. The vendor identification, assigned zip code and assigned category are stored along with a coupon at a server associated with the portal. It should be noted, the coupons may also be changed for a single vendor across geographical locations or categories if in fact the vendor has purchased advertisement rights corresponding to more than one zip code or more than one category.

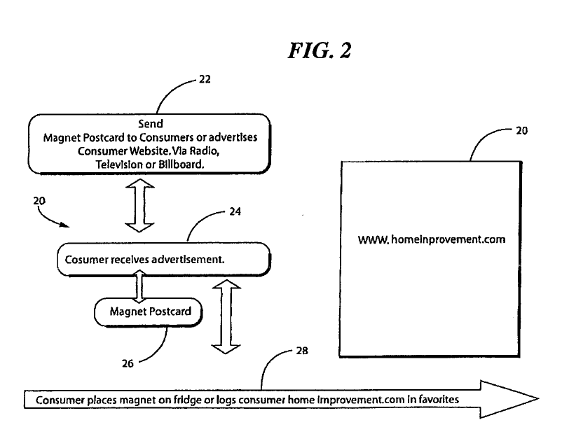

Referring to FIG. 2, there is illustrated a detailed schematic representation of the method for the consumer activation mode, generally indicated at 20, with the portal of the subject invention.

Initially, at step 22, the consumer is made aware of the portal 30 through advertising of the website (portal) and service itself. Information directing consumers to a web-based vendor promotions portal (website) is presented to a consumer by any one of a magnet postcard 20 sent by mail in step 26, or through radio, billboard or television advertisements as in step 24. These methods are not mutually exclusive, and in a preferred example are used in a non-mutually limiting combination. At step 24, a consumer receives the information directing the consumer to the web-based promotions portal. The magnet is designed to attract the potential consumer to it. At step 28, the consumer places the magnet on a metallic surface such as a refrigerator, or places the portal's URL in its web browser's favorites as a continual advertisement for the portal and its services. In this way, there is a “low tech-high touch” reminder of the service.

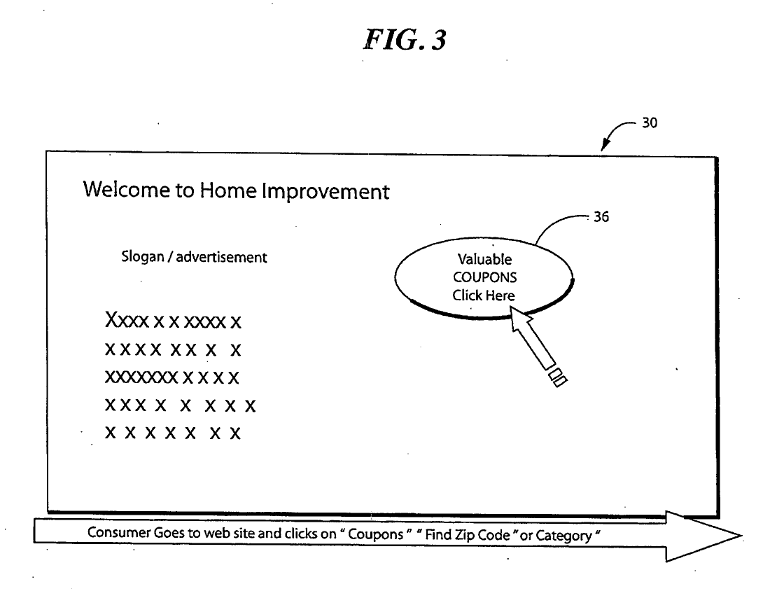

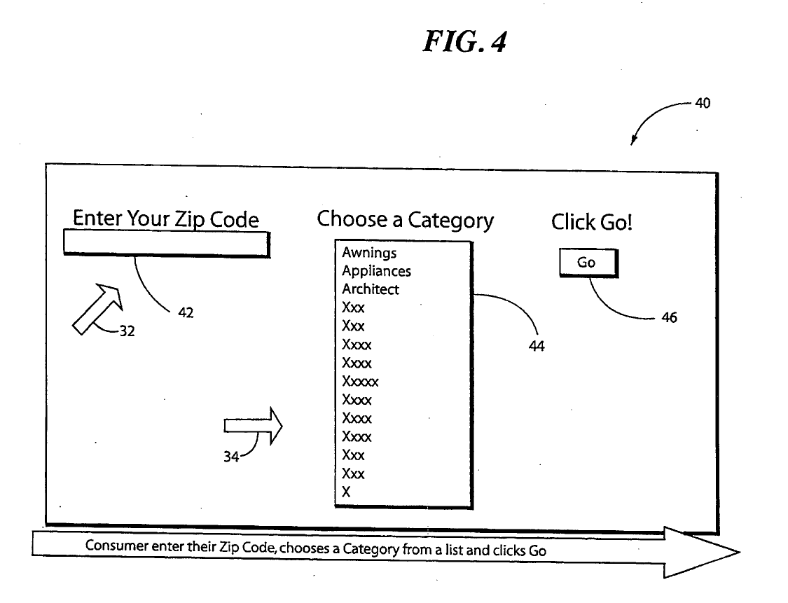

Referring to FIG. 3, a first portal page 30 for implementing the method of the invention is shown. By selecting the entry icon 36, valuable coupons click here, by way of non-limiting example, the process enters a menu mode at portal 30 as shown in FIG. 4. At step 32, a consumer can search online for vendor promotions within a selected geographic region by inputting zip codes. At step 34, a consumer can search online for vendor promotions by category. The search may be performed by any remote device capable of using a net browser such as a computer, cellular phone, personal digital assistant, or the like.

Referring now to FIG. 4, in the searching mode 40 method of the subject invention, at step 42, a zip code entry box is displayed for a consumer to enter a zip code in order to retrieve vendor promotions for a selected geographic area. At step 44, a pull-down category menu is displayed for a consumer to select and retrieve a particular category of vendor promotions. At step 46, a button is displayed for a consumer to activate the vendor promotion search, retrieval, and display.

When entering a zip code, in step 42, and a category 44, the website searches the server for the vendor and associated coupon mapped to that zip code and category.

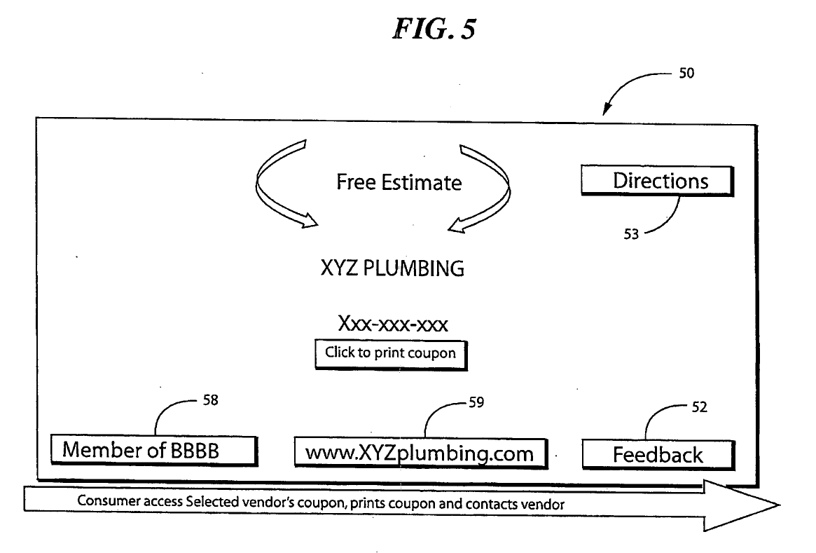

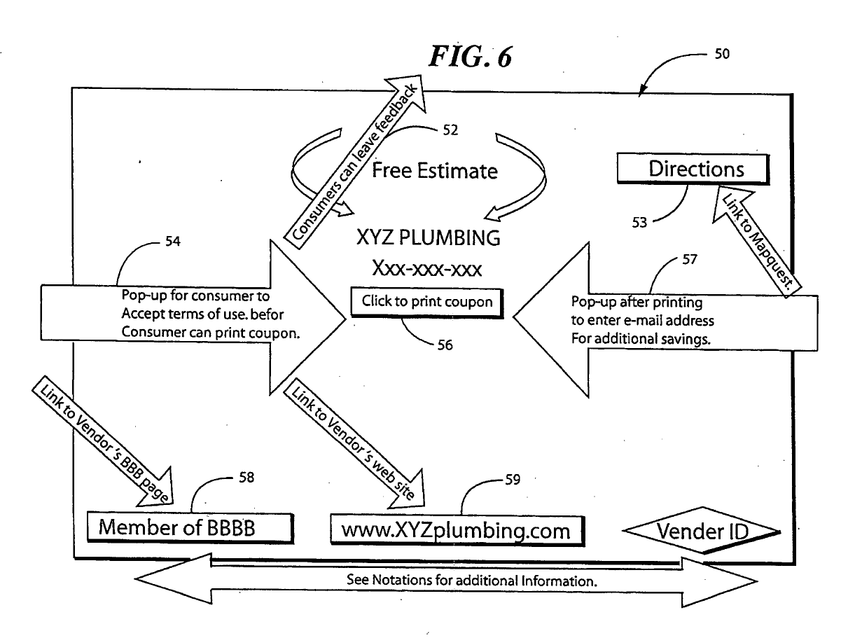

In a step 52, a coupon, such as display 50 (see FIG. 5.) is displayed at the remote computer of the consumer. Display 50 may include advertisement and offers such as a free estimate, a reduction in price, a link to the vendor's website or even directions or online ordering instructions by way of non-limiting example. In a step 58 (see FIG. 6), the consumer accesses the coupon, prints the coupon and then obtains his product or service in accordance with customary coupon shopping as known in the art.

In FIG. 6, in the vendor promotion display 50 in accordance with the invention is discussed in greater detail. A consumer may be presented with the following in a non-limiting exemplary example. A feedback icon 52 may be provided for a consumer to submit feedback to vendors. A directions button 53 may be provided to provide a consumer with a link to a map of a vendor's place of business or act as a hotlink to a map service such as MAPQUEST. A terms of use icon display 54 may be provided for a consumer to accept terms of use of a vendor promotion. A print coupon icon 56 is provided for a consumer to print a retrieved vendor promotion. An email entry display 57 is provided to enable a consumer to enter an email address for receiving future promotion. A vendor accreditation icon 58 for directing a consumer to confirm a vendor's accreditation; and vendor website button 59 for directing a consumer to a vendor's website.

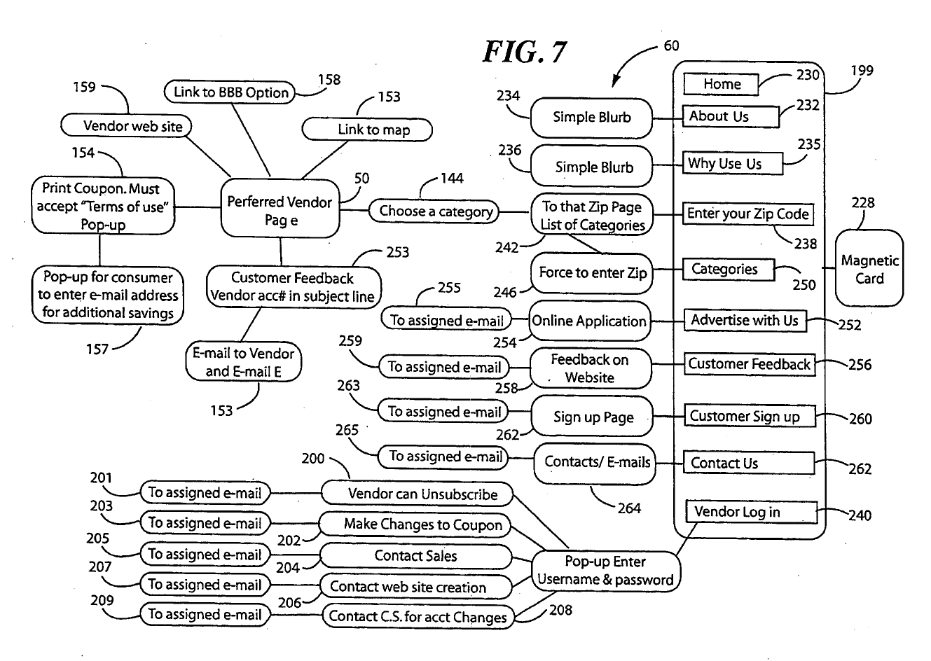

In FIG. 7, there is illustrated a detailed schematic representation of the vendor/customer/website customization mode 60 of the method of the subject invention. A magnetic card 228 or other advertisement, drives users to the website/portal 199. Portal 199 includes a plurality of steps/icons (the terms may be considered interchangeable as the step is utilizing the icon in the schematic representation). Portal 199 includes a home icon 230 that sends either the vendor or the consumer to the appropriate home page. An icon 232, when selected, links to a simple blurb 234 describing what portal 199 is and how it works. An icon 236 at portal 199 links to a simple blurb 236 when activated, discussing the advantages to using portal 199. An enter zip code icon 238, much like 42 from FIG. 4, links to the list of categories 242 corresponding to that zip code. Conversely, a category icon 244 may be chosen at portal 199, an icon 246 appears forcing the choice of a zip code, and processing again proceeds at list 242, which marries zip codes to categories. From there, based upon the choice of category 144, operation may continue at a preferred vendor page 50 as will be discussed in detail below.

Portal 199 also has a provisioning icon, an advertise with us icon 252 which may include the tutorial provided in step 16 above, and then links to an online application 254, which upon completion by a vendor is sent to an assigned e-mail address 255 for processing.

A customer feedback process is accomplished through a customer feedback icon 256 at portal/website 199. Customer feedback links to a feedback input 258 as known in the art. The feedback is sent to an assigned e-mail 259.

Similarly, consumers may sign up for offerings through an icon 260 provided at web portal 199 to allow consumers to sign up for any programs offered by portal 199. Icon 260 would link to a sign up page 262 where the appropriate contact information would be sent to an assigned e-mail address 263 for processing and registration. If any entity wishes to contact website 199 and provide feedback without signing up as a vendor or for consumer benefits, then a contact US icon 262 links to a contacts e-mails 264 page where questions or information may be posted. This information is then e-mailed to an assigned e-mail address 265 for processing.

Vendor fields are customizable, and include, but are not limited to, a link to a vendor's website 50, a link to the vendor's reference on the Better Business Bureau website 158 (accessed in step 58 described above), a link 153 to a map to the vendor's place of business (accessed in step 53); a link 154 to the vendor's terms of use of a promotion (accessed in step 54); a consumer e-mail entry display 157 (accessed in step 57) for receipt of future promotions; and a consumer feedback field 253 for routing back to the vendor.

In the vendor customization mode, a vendor logs in at a step 240 to change their use of the portal 199. A vendor can also unsubscribe from the advertising service in a step 200 by e-mailing to an assigned address 201. A vendor may change promotions in a step 202 at the website by making online changes or e-mailing changes to a Webmaster at an e-mail address 203. Vendors may contact customer service for the portal in a step 204 to create a new website in a step 206 by e-mailing a Webmaster at an assigned e-mail address 207. A vendor may make account changes by contacting Customer Services in step 208 at an e-mail address 209.

In a preferred embodiment, a local vendor may be featured on a magnet, billboard or broadcast advertising. A co-promotion with the portal web address is done. In this embodiment, the advertisement is coextensive with the geographical area of the vendors offering at the portal.

While the method of subject invention has been shown and described with reference to preferred embodiments, those skilled in the art will readily appreciate that changes and/or modifications may be made thereto without departing from the spirit and scope of the subject invention.

What is claimed as new and desired to be protected by Letters Patent of the United States is:

1. A method for providing consumer-driven vendor-tracked web-based direct mail advertising comprising the steps of:
provisioning a vendor to advertise on a portal by obtaining a zip code corresponding to a geographical area and a category of at least one of services or goods provided by a vendor within the geographical area;
storing a vendor associated advertisement accessible across a distributed network;
mapping the advertisement to the corresponding zip code and category of the vendor;
making the advertisement available at the portal;
providing access to the portal by consumers from a consumer remote device;
at least one consumer inputting a geographical location and category of goods or services at the portal;
retrieving a coupon corresponding to the geographical location and goods or services input by the consumer and displaying the goods or services to the consumer at the consumer remote device.

2. The method of claim 1, wherein said geographic location is represented by a zip code.

3. The method of claim 1, further comprising the step of mailing a magnet advertisement having the portal thereon address to potential consumers.

4. The method of claim 1, wherein said advertisement is a coupon.

5. The method of claim 4, further comprising the step of a consumer printing the coupon at the consumer device.

6. The method of claim 1, further comprising the step of a vendor tracking consumer activity on the portal.

7. Wherein the portal is associated with a URL; and further comprising the step of providing a billboard advertisement within the geographical area to advertise the URL.

8. The method of claim 1, wherein the portal is associated with a URL; and further comprising the step of broadcasting a television advertisement of the URL.

9. The method of claim 1, wherein the portal is associated with a URL; further comprising the step of broadcasting a radio advertisement for the URL.
